(19) United States
(12) Patent Application Publication
(10) Pub. No.: US 2009/0208891 A1
(43) Pub. Date: Aug. 20, 2009

(54) Self supporting kiln insulation covers

(76) Inventor: Mark A. Thompson, Midland, MI (US)

Correspondence Address: MCKELLAR IP LAW, PLLC, 784 SOUTH POSEYVILLE ROAD, MIDLAND, MI, 48640, US

(21) Appl. No.: 12/322,384

(22) Filed: Feb. 2, 2009

Related U.S. Application Data
(60) Provisional application No. 61/066,251, filed on Feb. 19, 2008.

(51) Int. Cl. F27B 7/00

(52) U.S. Cl. 432/103

(57) ABSTRACT

Self supporting kiln insulation device comprising an outer layer having an inside surface, at least two insulation modules, at least two heat dams, and, a stationary support structure. The insulation modules do not touch the kiln and heat dams are located adjacent to and touching the kiln, and are spaced at random and at predetermined distances apart from each other.

This application is an original application based on U.S. Provisional patent application having Ser. No. 61/066,251, filed on Feb. 19, 2008 and U.S. Utility patent application having Ser. No.

The invention disclosed and claimed herein deals with a new insulation device that is a self supporting kiln insulation cover.

### BACKGROUND OF THE INVENTION

Commonly used at cement and asphalt plants, kilns, especially rotary kilns are found in many manufacturing processes, including the chemical, pharmaceutical, food processing, agricultural and highway material industries. Rotary kilns are large horizontal cylinders set up on a slight angle, rotating to mix materials together and depending on gravity to work the material down the length of the kiln. Rotary kilns can range from 30 800 feet in length and range between 12 and 20 feet in diameter.

Rotary kilns are not the only structures for kilns, as kilns for various manufacturing processes take on other configurations, such as square, triangular, etc.

Kilns are fueled by materials such as petroleum, natural gas, oil, coal, and even used tires and other industrial waste. The kilns operate at high temperatures in order for chemical reactions to occur and the gas flame shooting down the middle of the tube-like structure can often reach 3400° F. (1870° C.), about one third of the temperature of the sun's surface. With the heat of this machine reaching such extremes, the question of energy efficiency is often associated with kilns.

Kilns are insulated with firebrick sandwiched in between the outside metal cylinder and the inside layer. This structure allows for the outside shell to still become very hot, and some studies suggest that an estimated forty percent of total input energy is being lost. Attempts to conserve this energy have been made in the past, but most of them have consisted of putting insulation directly on the surface of the outside rotating shell. Over a period of time, this resulted in a sagging egg shaped layer of insulation hanging around the kiln.

Such insulation methods can be found for example, in U.S. Pat. No. 4,932,863 that issued on Jun. 12, 1990 to Anderson, in which a drum dryer for use in the manufacture of bituminous concrete asphalt is provided with a jacket that is insulated. The jacket is strapped directly to the outside of the drum wall.

In addition, U.S. Pat. No. 5,695,329, that issued Dec. 9, 1997 to Orcutt, deals with an outer jacket that is mechanical attached directly to the outside surface of the kiln.

With the cost of energy quickly rising, the need for a new rotary kiln invention is in high demand.

### THE INVENTION

Thus, what is disclosed and claimed herein is a self supporting kiln insulation cover, said self supporting kiln insulation cover comprising in combination an outer layer having an inside surface; at least two modules; at least two heat dams, and, a stationary support structure.

The insulation modules are located adjacent to the outer layer, on the inside surface thereof, such that the insulation modules do not touch the kiln.

The heat dams are located adjacent to and touching the kiln, and are spaced at random, and at predetermined distances apart from each other.

The stationary support structures are located so as to support the self supporting kiln insulation cover independent of the kiln.

### BRIEF DESCRIPTION OF THE DRAWINGS

FIG. 1 is a full side view of an insulated rotary kiln of this invention.

FIG. 2 is a cross sectional end view through line A-A of FIG. 1.

FIG. 3 is an enlarged section of FIG. 4 at point P.

FIG. 4 is a cross sectional end view through line B-B of FIG. 1.

FIG. 5 is a full view of a V-shaped heat dam.

FIG. 6 is a full view of an I-shaped heat dam.

FIG. 7 is a full view of an inverted V-shaped heat dam.

### DETAILED DESCRIPTION OF THE DRAWINGS

This invention consists of an outer supported structure floating over the kiln, supported by stationary support systems. Inside the stationary cover, insulation modules are used to keep an air gap between the insulated over and the kiln. Keeping the two apparatii from touching each other guarantees a long production life and creates a smaller chance for physical damage to occur. Air is a good insulator when it is controlled. In the instant invention, the air continues to recycle itself, flowing between the two structures. The design call for thermal dams placed strategically along the kiln at random, predetermined distances apart, specifically at transitions and other areas in need of support. The dams wear against the side of the kiln, but can be easily replaced. There is minimal contact with the kiln surface, eliminating the chance of abrasion and deformation of the insulation.

In this invention, it is best if most of the insulation is in the top and the sides of the kiln jacket, due to the fact that heat rises.

It is contemplated within the scope of this invention to use an air recycling system to preheat materials, taking hot air from in between the jacket and the actual. This is used to heat the raw mix of materials and get it ready for the kiln. This is very similar to a gas-suspension pre-heater, using cyclones to create an energy reaction in the raw mix. This essentially reduces the amount of heat that is wasted to the atmosphere and lets the kiln produce a higher output.

This creates a more energy efficient machine, but the overall process becomes more productive. In order for the kiln to operate efficiently, conditions must remain constant throughout the machine. To ensure productivity, the temperature of the material and the gas must be optimized and maintained at all times.

The instant invention is not limited by the design of the kiln and is not limited by the type of insulation that is used therein. Such insulation can be, for example, Fiberglass, glass fiber, mineral wool, foam glass, cellular glass, ceramic fiber, and polyisocyanurates, to name a few. For purposes of this invention, a combination of the insulations can be used, for example, one segment along the kiln can have ceramic insulation while the adjacent segment may have glass fiber, and so on.

Companies furnishing such materials are well-known and are, for example, Tempmat, Trymer, Hi-Therm, Saint Gobain, John's Manville, Owens Corning, Roxual, Fibrex, Pittsburg Corning, Zhejiiang Zehnshen Cold Insulation Technology, and Jiaxing Zehnhua Heat.

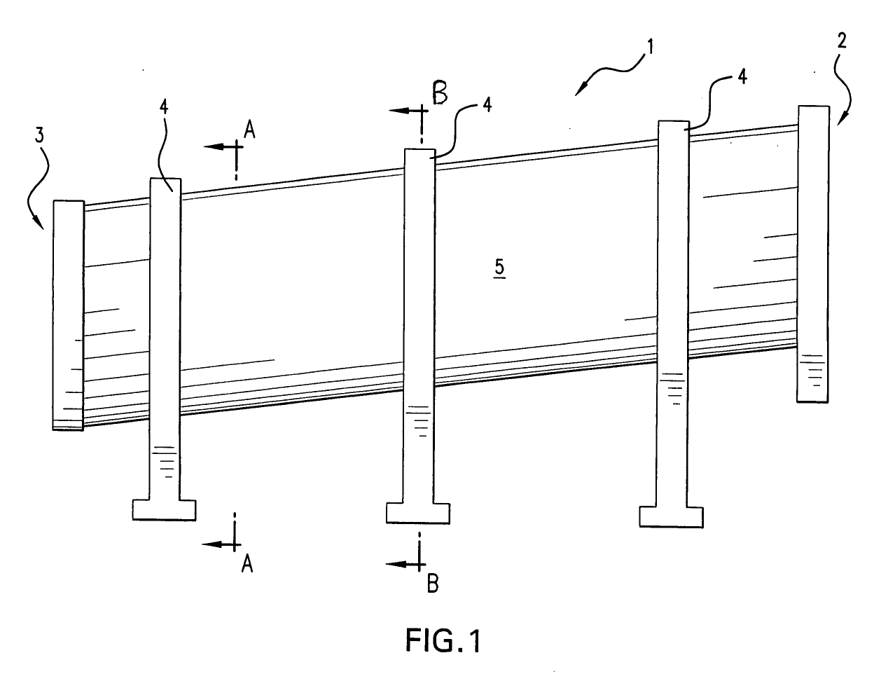

Turning now to FIG. 1, there is shown a full side view of an insulated rotary kiln 1 in which the feed end is located at 2 and the exit end at 3. The insulated kiln 1 is supported by a support structure 4.

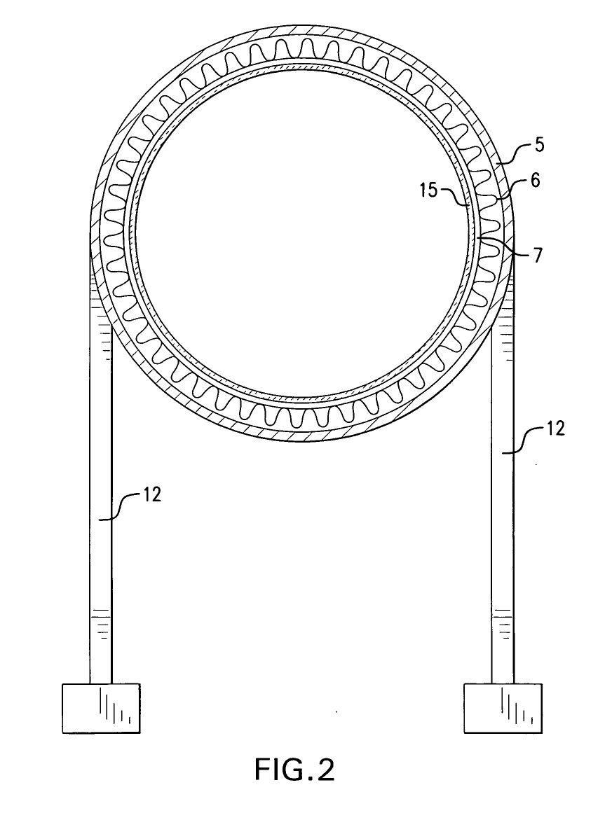

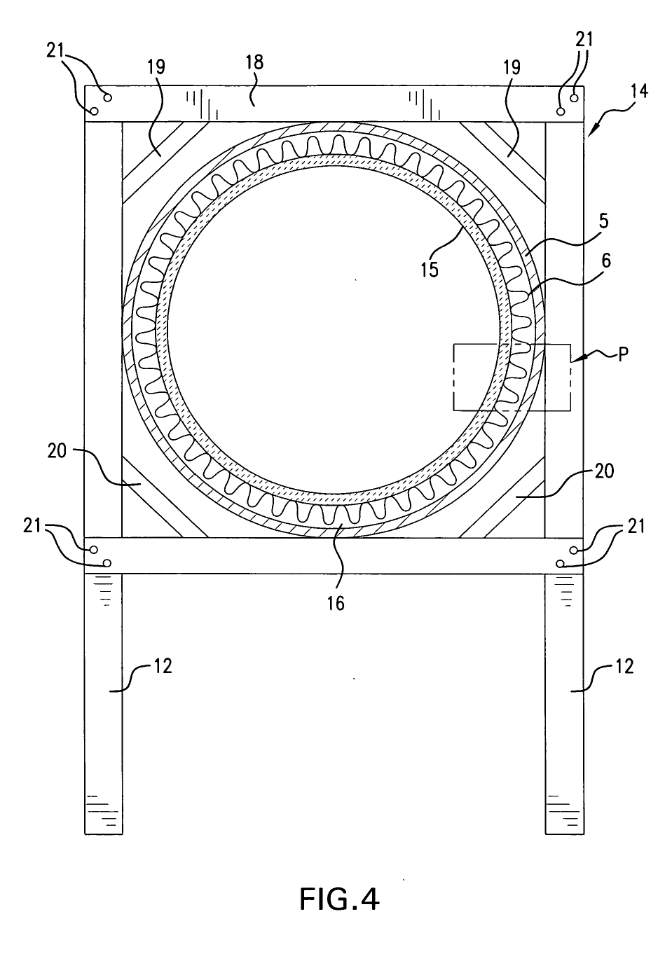

The outer covering, or shell 5, can also be observed in this Figure. FIGS. 2 and 4 show the actual kiln 15. The outer shell 5 can be fabricated from plastic, metal, rubber, ceramics, concrete, mortar, brick, wood, and, asphalt, or any other convenient material as long as one takes into consideration the amount of heat that is generated by the end use for the kiln. Plastics can be used and such plastics can be selected from polyethylene, crosslinked polyethylene, polypropylene, urethane, and, Polyester to name a few.

Favored metals can be, for example, Aluminum, Steel, Iron, Tin, and, Magnesium.

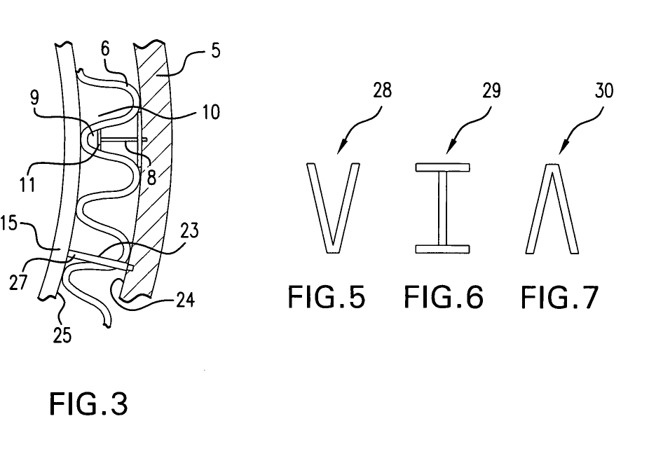

FIG. 2 is a cross sectional view of the insulated kiln 1 at line A-A of FIG. 1 showing the use of stationary legs 12 for support of the insulation portion 6 of the device 1, further showing the outer shell 5, the insulation 6, and the inner support 7. For purposes of this invention, there can be used an inner support 7, or there can be a another mode of supporting the insulation 6, for example, and with reference to FIG. 3 which is an enlarged portion under the square P in FIG. 4, the support can be by a hanger 8 that is supported by the outer shell 5. The end 9 opposite the contact with the outer shell 5 can contain a pin 10 to support the insulation 6, or there can be a plate 11 all as shown in FIG. 3. Support layer 7 can be for example hardware cloth, chicken wire, or some other open spaced net or wires that will hold the insulation 6 in place.

It should be understood that both the pin 10 and the plate 11 are shown, but this is for illustration purposes only and only one of or the other of these modes of support can be used.

For purposes of this invention, one can use the support mechanism for the insulation 6 as is shown in FIG. 3, or one can use an inner covering 7.

It should be noted that the portion of the cross section shown in FIG. 2 shows support legs 12 and does not show the support frame 13 as is shown in FIG. 4.

Turning now to FIG. 4, which is a cross sectional view of the invention through line B-B of FIG. 1, there is shown another embodiment of support for the invention.

Thus, there is shown a rack or frame 14 for supporting the insulation 6 around the actual kiln 15. The rack 14 consists of legs 12 that project above the bottom 16 of the kiln and which are attached to each other by cross bars 17 and 18. There is also shown braces 19 and 20 and fasteners 21 in the portions of the rack 14 where the cross bars 17 and 18 meet the legs 12, both at the top and the bottom.

Returning to FIG. 3, there is shown a heat dam 23 of this invention. The heat dam 23 is fastened into the inner surface 24 of the cover 5 and projects towards the outer surface 25 of the actual kiln 15 or in some insulations, it can be pressure fitted without actual pinning. The end 27 of the heat dam 23 actually touches the outer surface 25 of the actual kiln 15. It is designed so that it touches very lightly against the surface 25 such that very little heat escapes around it, but does not touch hard enough to create excessive wear on either the heat dam 23 or the outer surface 25 of the actual kiln 15. The heat dams are designed to be removed and replaced.

Most effective seems to be the straight rod type 23 as shown in FIG. 3, however, it is contemplated within the scope this invention to use other configurations for the heat dam 23, for example in FIGS. 5, 6, and 7 wherein it is shown a V-shaped dam 28, an I-shaped dam 29 and an inverted V-shaped dam 30.

The heat dams 23, or 28, 29 and 30 can be randomly spaced along the outer surface 25 of the actual kiln 15 and these dams 23 completely circumferentially surround the actual kiln 15. Typically, these heat dams are spaced from 6 feet to 12 feet apart from each other, however, it is common to place them in an area that may be susceptible for losing heat, such as a transitional area of the kiln 15 and thus, they may not and are not required to have even spacing from each other.

What is claimed is:

1. Self supporting kiln insulation device, said self supporting kiln insulation device comprising in combination:
an outer layer having an inside surface;
at least two insulation modules;
at least two heat dams, and, a stationary support structure,
wherein said insulation modules are located adjacent to the outer layer, on the inside surface thereof, such that the insulation modules do not touch the kiln;
and wherein, all the heat dams are located adjacent to and touching the kiln, and are spaced at random and at predetermined distances apart;
said stationary support structure being located so as to support the self supporting kiln insulation cover.

2. The self supporting kiln insulation device as claimed in claim 1, wherein the outer layer is fabricated from a material selected from the group consisting essentially of
i. plastic,
ii. metal,
iii. rubber,
iv. ceramics,
v. concrete,
vi. mortar,
vii. brick,
viii. wood, and,
ix. asphalt

3. The self supporting kiln insulation device as claimed in claim 2, wherein the plastic is selected from the group consisting of:
i. polyethylene,
ii. crosslinked polyethylene,
iii. polypropylene,
iv. urethane, and,
v. Polyester.

4. The self supporting kiln insulation device as claimed in claim 3 wherein the plastic is reinforced.

5. The self supporting kiln insulation device as claimed in claim 4 wherein the plastic is reinforced with fiber.

6. The self supporting kiln insulation device as claimed in claim 2, wherein the metal is selected from the group consisting of:
i. Aluminum,
ii. Steel,
iii. Iron,
iv. Tin, and,
v. Magnesium.

7. The self supporting kiln insulation device as claimed in claim 6 wherein the metal is aluminum.

8. The self supporting kiln insulation device as claimed in claim 6 wherein the metal is steel.

9. The self supporting kiln insulation device as claimed in claim 1 wherein the insulation is fabricated from glass fibers.

10. The self supporting kiln insulation device as claimed in claim 1 wherein the insulation is fabricated from foam.

11. The self supporting kiln insulation device as claimed in claim 1 wherein the insulation is fabricated from ceramics.

12. The self supporting kiln insulation device as claimed in claim 11 wherein the insulation is fabricated from ceramic fiber.
